(19) United States
(12) Patent Application Publication
(10) Pub. No.: US 2013/0164493 A1
(43) Pub. Date: Jun. 27, 2013

(54) Window for Mobile Device and Mobile Device Including the Window

(71) Applicant: Akira Hirai, Seoul (KR)

(72) Inventor: Akira Hirai, Seoul (KR)

(73) Assignee: SAMSUNG DISPLAY CO., LTD., Yongin-City (KR)

(21) Appl. No.: 13/565,588

(22) Filed: Aug. 2, 2012

(30) Foreign Application Priority Data
Dec. 21, 2011 (KR) 10-2011-0139439

(51) Int. Cl. B32B 27/06; B32B 5/16; B32B 17/00; C09J 121/00; B32B 5/12; B32B 5/00; B32B 5/02; C09J 7/02; B32B 18/00

(52) U.S. Cl. 428/113; 428/446; 428/500; 428/423.1; 428/323; 428/426; 428/702; 428/336; 428/339; 428/412; 428/523; 428/480; 428/335

(57) ABSTRACT

A window for mobile device includes a first resin layer and a second resin layer. The first resin layer may include a transparent adhesive resin and a plurality of support members distributed on the transparent adhesive resin. The second resin layer is disposed on one side of the first resin layer and may include a hard transparent resin.

### CLAIM OF PRIORITY

This application makes reference to, incorporates the same herein, and claims all benefits accruing under 35 U.S.C. §119 from an application earlier filed in the Korean Intellectual Property Office on the 21 Dec. 2011 and there duly assigned Serial No. 10-2011-0139439.

### BACKGROUND OF THE INVENTION

1. Field of the Invention

The present invention relates to windows for a mobile device and mobile devices including the windows, and more particularly, to a window that can be bent for a mobile device and a mobile device including the window.

2. Description of the Related Art

As the information society has developed, various display panels such as an organic light emitting diode (OLED) panel, a liquid crystal display (LCD) panel, an electro phoretic display (EPD) panel and an electro wetting display (EWD) panel are being applied to a mobile device.

The mobile devices may be of various types depending on user requirements, and recent users require mobile devices having a flexible feature. Thus, a study of a display panel having a flexible feature is actively in progress.

To apply the display panel to a mobile device, a window is disposed in a direction in which an image of the display panel is displayed.

Thus, in order for the mobile device to have a flexible feature, the window as well as the display panel should have a flexible feature.

### SUMMARY OF THE INVENTION

Embodiments of the invention provide a window for a mobile device. The window for the mobile device may include a first resin layer including a transparent adhesive resin and a plurality of support members distributed on the transparent adhesive resin, and a second resin layer disposed on one side of the first resin layer and including a hard transparent resin.

Embodiments of the invention also provide a mobile device. The mobile device may include a display panel displaying an image, and a window for mobile device disposed in a direction in which a light is outputted from the display panel. The window for the mobile device may include a first resin layer including a transparent adhesive resin and a plurality of support members distributed on the transparent adhesive resin and including a first side toward the display panel and a second side facing the first side, and a second resin layer disposed on the second side of the first resin layer and including a hard transparent resin.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view for describing a mobile device to which a window for mobile device in accordance with embodiments of the invention is applied;

FIG. 2 is a cross sectional view for describing the window for mobile device in accordance with embodiments of the invention;

FIG. 3 is a cross sectional view for describing the window for mobile device in accordance with other embodiments of the invention; and

FIGS. 4 and 5 are cross sectional views for describing the window for mobile device in accordance with other embodiments of the invention.

### DETAILED DESCRIPTION OF THE INVENTION

Embodiments of invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like reference numerals refer to like elements throughout.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

It will be further understood that the terms “comprises” and/or “comprising,” or “includes” and/or “including”, when used in this specification, specify the presence of stated features, regions, integers, steps, operations, elements, components and/or groups thereof, but do not preclude the presence or addition of one or more other features, regions, integers, steps, operations, elements, components, and/or groups thereof. It will also be understood that, when an element such as a layer, region or substrate is referred to as being “on” or “onto” another element, it may lie directly on the other element or intervening elements or layers may also be present. Like reference numerals refer to like elements throughout the specification.

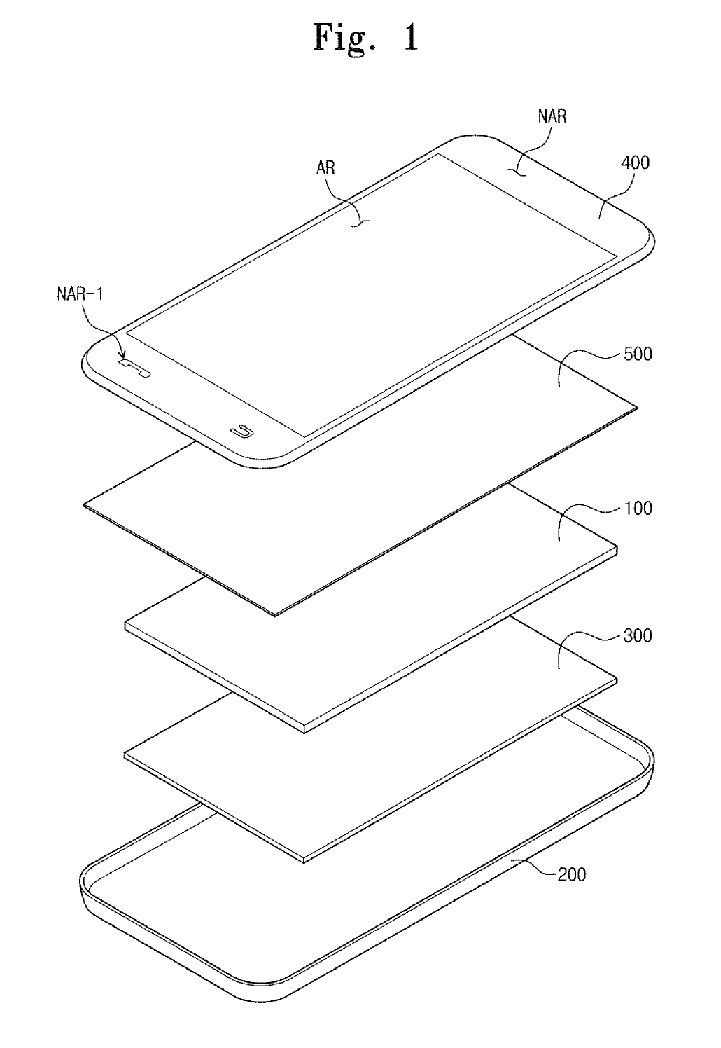

FIG. 1 is a perspective view for describing a mobile device to which a window for mobile device in accordance with embodiments of the invention is applied.

Referring to FIG. 1, a mobile device in accordance with embodiments of the invention includes a display panel 100, a housing 200 for receiving the display panel 100, a window 400 disposed on the display panel 100, and a shock-absorbing sheet 300 disposed between the display panel 100 and the housing 200. Also, the display panel 100, the housing 200, the window 400 and the shock-absorbing sheet 300 may have a flexible feature. Thus, the mobile device in accordance with some embodiments may have a flexible feature.

The display panel 100 may display an image. The display panel 100 is not limited. For example, the display panel 100 may include a self light-emitting display panel such as an Organic Light Emitting Display (OLED) panel. Furthermore, the display panel 100 may include a non-emissive display panel such as a Liquid Crystal Display (LCD) panel, an ElectroPhoretic Display (EPD) panel and a ElectroWetting Display (EWD) panel, and the like. When the non-emissive display panel is used as the display panel 100, the mobile device may include a back-light unit providing a light to the display panel 100. In the present embodiments, the OLED panel is applied to the display panel 100.

The display panel 100 may include a display substrate (not shown) that includes a plurality of pixels to display an image, a scan drive (not shown) and a data drive (not shown).

The scan drive and the data drive are connected to respective signal interconnections so as to be electrically coupled to the display substrate. The signal interconnection may include a scan line, a data line and a power supply line, and any one interconnection may cross another interconnection.

Each pixel of the display panel may be electrically connected to a corresponding data line among the data lines, a corresponding scan line among the scan lines, and a corresponding power supply line, respectively. Each pixel may include a switching thin film transistor (not shown), a driving thin film transistor (not shown), a capacitor (not shown) and an OLED (not shown). The OLED includes a first electrode connected to a drain electrode of the driving thin film transistor, an organic film disposed on the first electrode, and a second electrode disposed on the organic film. One of the first and second electrodes may be an anode and the other may be a cathode.

The organic film includes an emitting layer and may have a multilayer thin film structure. For example, the organic film may include a hole injection layer injecting a hole, a hole transport layer having a superior hole transportation and blocking movement of an electron not combined in the emitting layer so as to increase a chance of recombination of a hole and an electron, the emitting layer emitting a light by a recombination of an electron and a hole, a hole blocking layer for blocking movement of a hole not combined in the emitting layer, an electron transport layer for smoothly transporting an electron to the emitting layer and an electron injection layer injecting an electron.

The housing 200 receives the display panel 100. In FIG. 1, housing 200 which includes one member having a space that can receive the display panel 100 is provided as an illustration. However, the housing 200 may include two or more members. In the present embodiment, the housing 200 including one member is described as an illustration.

Also, the housing 200, besides the display panel 100, may further receive a printed circuit board (PCB) (not shown) on which a plurality of active elements and a plurality of passive elements are mounted. The housing 200 may further receive a power supply part, such as a battery, depending on the type of display panel.

The shock-absorbing sheet 300 is disposed between the display panel 100 and the housing 200 to absorb an external shock that can be provided to the display panel 100. Thus, the shock-absorbing sheet 300 prevents an external shock from being directly provided to the display panel 100.

The shock-absorbing sheet 300 includes a shock-absorbing film (not shown) that can absorb an external shock and an adhesive layer (not shown) which is spread on at least one side of the shock-absorbing sheet 300. For example, the adhesive layer is spread on one side of the shock-absorbing film so that the shock-absorbing sheet 300 is fixed to the display panel 100 or the housing 200. The shock-absorbing film may include a rubber foam or laminated material of the rubber foam, and may have a thickness of 300 μm.

The window 400 is disposed in a direction in which an image is outputted from the display panel 100, and is combined with the housing 20 to constitute an outside surface of the display device together with the housing 200.

The window 400 includes a display area AR on which an image generated from the display panel 100 is displayed and a non-display area NAR adjacent to at least a part of the display area AR. The image is not displayed on the non-display area NAR. At least a part of the non-display area NAR may be defined as an input icon area NAR-1. The input icon area NAR-1 may be activated when the display device operates in a specific mode.

The display device in accordance with the present embodiment may further include an adhesive sheet 500 disposed between the display panel 100 and the window 400. The adhesive sheet 500 attaches the window 400 to the display panel 100. The adhesive sheet 500 may be transparent to prevent the brightness of the image output from the display panel 100 from being reduced.

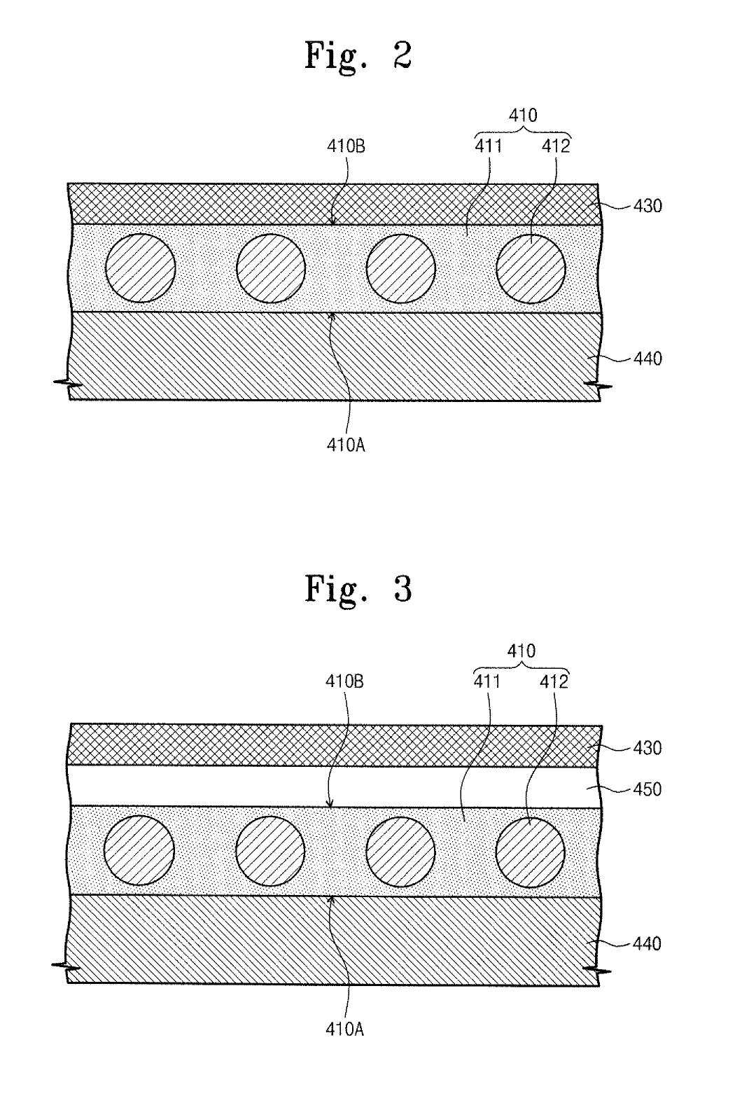

FIG. 2 is a cross sectional view for describing the window for mobile device in accordance with some embodiments of the invention.

Referring to FIG. 2, the window 400 for the mobile device may include a first resin layer 410, a second resin layer 430 disposed on one side of the first resin layer 410, and a support film 440 disposed on the other side of the first resin layer 410.

The first resin layer 410 includes a first side 410A and a second side 410B facing the first side 410A. The first side 410A may be a side facing toward the display panel 100.

The first resin layer 410 has a thickness of 10 μm˜500 μm and includes a transparent adhesive resin 411 and a plurality of support member 412 distributed on the transparent adhesive resin 411.

The coefficient of volume elasticity of the transparent adhesive resin 411 may be 0.01 GPa or less. It is desirable that the coefficient of volume elasticity of the transparent adhesive resin 411 is 1 MPa or less. The transparent adhesive resin 411 may include any one selected from a silicon adhesive resin, a rubber adhesive resin, an acrylic adhesive resin, a urethane adhesive resin and equivalent thereof. The acrylic adhesive resin may be an acrylic ester copolymer. The first resin layer 410 is a base substrate of the window 400 for mobile device in accordance with the present embodiment and gives fluidity to the window 400 for mobile device.

The support member 412 may be added to the transparent adhesive resin 411 at the rate of 10 ppm˜100 ppm with respect to weight of the transparent adhesive resin 411, and may be distributed on the transparent adhesive resin 411.

The support members 412 may be a short staple or a spherical particle having a coefficient of volume elasticity of 1 GPa or more. The support member 412 may include at least one selected from silicate glass material, alumina ceramic material, acrylic organic material and equivalents thereof. The acrylic organic material may be polymethylmethacrylate (PMMA).

The diameter of the cross section of the support member 412 may be less than the thickness of the first resin layer 410. For example, the diameter of the cross section of the support member 412 may be 2 μm˜100 μm. The difference between the thickness of the first resin layer 410 and the diameter of the cross section of the support member 412 may be 30 μm or less. It is desirable that the difference between the thickness of the first resin layer 410 and the diameter of the cross section of the support member 412 is 10 μm or less. When the second resin layer 430 sinks due to an external pressure, the support members 412 support the second resin layer 430.

The difference between a refractive index of the support member 412 and a refractive index of the transparent adhesive resin 411 may be 0.1 or less. This is to reduce light totally reflected at an interface between the support members 412 and the transparent adhesive resin 411 with respect to light entering the first resin layer 410.

The light may be totally reflected at an interface between the support members 412 and the transparent adhesive resin 411. The total reflection is a phenomenon that, when light travels from a material having a high refractive index to a material having a low refractive index, light entering at an incident angle greater than a specific critical angle is not refracted but is totally reflected.

The greater the difference between the refractive index of the support member 412 and the refractive index of the transparent adhesive resin 411 is, the smaller a critical angle of total reflection at an interface between the support members 412 and the transparent adhesive resin 411 is. Thus, the greater the difference between the refractive index of the support member 412 and the refractive index of the transparent adhesive resin 411 is, the wider a range of angle at which light can be totally reflected at an interface between the support members 412 and the transparent adhesive resin 411 is. Thus, the amount of totally reflected light may increase. That is, if the difference between the refractive index of the support member 412 and the refractive index of the transparent adhesive resin 411 is great, the support members 412 perform a function of haze in the first resin layer 410. Thus, a part of light output from the display panel of the mobile device is totally reflected by the support member 412 the and the routes of the light totally reflected may be changed. It may be disturbed by the support members 412 so that viewers view a clear image. As the difference between the refractive index of the support member 412 and the refractive index of the transparent adhesive resin 411 is small, the amount of light totally reflected at an interface between the support members 412 and the transparent adhesive resin 411 is reduced. Thus, viewers can view most of the light outputted from the display panel for mobile device, and can view a clear image.

In a table below, values are recorded which measure an interface reflection index and a critical angle of total reflection in accordance with a refractive index of the transparent adhesive resin 411 and a refractive index of the support member 412. The support members 412 use a silicate glass material having a refractive index of 1.5.

TABLE 1
An interface reflection index and a critical angle of total reflection in accordance
with the refractive index of the transparent adhesive resin 411 and the refractive index of the
support member 412.

| | | | | | | | | |
|---|---|---|---|---|---|---|---|---|
| n1 | 1.70 | 1.60 | 1.58 | 1.56 | 1.54 | 1.52 | 1.50 | 1.48 |
| n0 | 1.50 | 1.50 | 1.50 | 1.50 | 1.50 | 1.50 | 1.50 | 1.50 |
| Interface | 0.391 | 0.104 | 0.067 | 0.038 | 0.017 | 0.004 | 0.000 | 0.005 |
| reflection index | | | | | | | | |
| (%) | | | | | | | | |
| Critical angle (°) | 61.9 | 69.6 | 71.7 | 74.1 | 76.9 | 80.7 | 90.0 | — |

The reflection critical angle may be calculated by mathematical formulas below.

$$\begin{matrix}R = \frac{{( {n}_{0} - {n}_{1} )}^{2}}{{( {n}_{0} + {n}_{1} )}^{2}} & < Mathematical Formula 1 > \\ θ = {sin}^{- 1} ( \frac{{n}_{0}}{{n}_{1}} ) & < Mathematical Formula 2 >\end{matrix}$$

In the equation above, R is an interface reflection index, θ is a critical angle of total reflection, n0 is a refractive index of the support member 412 having silicate glass material, and n1 is a refractive index of the transparent adhesive resin 411.

Referring to the Table 1, the more the difference between the refractive index of the transparent adhesive index 411 and the refractive index of the support member 412 is reduced, the more the interface reflection index is reduced. If the difference between the refractive index of the transparent adhesive index 411 and the refractive index of the support member 412 is 0.1 or less, the interface reflection index occurring at an interface between the refractive index of the transparent adhesive index 411 and the refractive index of the support member 412 is 0.104% or less.

As the difference between the refractive index of the transparent adhesive index 411 and the refractive index of the support member 412 becomes small, viewers viewing light penetrating the window 400 for mobile device find it difficult to feel reduction of observability.

The refractive index changes depending on the wavelength of light and the wavelength dependence of the refractive index. That is, an index representing a degree of distribution is defined as Abbe's number. The Abbe's number may be represented by a Mathematical Formula 3 below.

$${V}_{d} = \frac{( {n}_{D} - 1 )}{( {n}_{F} - {n}_{C} )} \qquad < Mathematical Formula 3 >$$

In the above equation, the Vd is Abbe's number, nC is a refractive index of C line is (wavelength 656 nm) of Fraunhofer's line, nD is a refractive index of D line (wavelength 589 nm) of Fraunhofer's line, and nF is a refractive index of F line (wavelength 486 nm) of Fraunhofer's line.

The degree of light distribution of material having the Abbe's number of 45 or more is low. Generally, since silicate glass material has Abbe's number of 50 or more and acrylic resin has Abbe's number of 45 or more, the first resin layer 410 may have a high penetration ratio in all wavelength areas of light.

The second resin layer 430 is disposed on one side, e.g., the second side 410B of the first resin layer 410, so as to protect the first resin layer 410 from the external environment. For example, the second resin layer 430 includes a hard transparent resin and may prevent a scratch from being generated on the first resin layer 410.

The second resin layer 430 may include at least one of a Sil-Sesqui-Oxane resin, an acrylic resin, a polycarbonate resin, an allyl resin, a polyester resin and an epoxy resin. The second resin layer 430 may be a single layer film including Sil-Sesqui-Oxane resin. The second resin layer 430 may be a laminated layer of film including a transparent plastic resin. The second resin layer 430 may be a film including a transparent plastic resin treated with a hard coating or a diamond-like-carbon coating.

The thickness of the second resin layer 430 may be smaller than the thickness of the first resin layer 410. For example, the second resin layer 430 may have a thickness of 5 μm˜100μm. This is to prevent deformation of the window 400 for the mobile device under a heating condition or a cooling condition.

If the coefficient of thermal expansion of the first resin layer 410 is different from the coefficient of thermal expansion of the second resin layer 430, under the heating condition or the cooling condition, the amount of contraction or the amount of expansion of the first resin layer 410 may be different from that of the second resin layer 430. For that reason, the first and second resin layers 410 and 430, respectively, may become stressed at an interface between the first and second resin layers 410 and 430, respectively. The stress deforms the first and second resin layers 410 and 430, respectively, and the deformation of the first and second resin layers 410 and 430, respectively, may be the cause of deformation of the window 400 for the mobile device.

If the thickness of the second resin layer 430 is smaller than the thickness of the first resin layer 410, stress occurring at an interface between the first and second resin layers 410 and 430, respectively, caused by the expansion and contraction may be reduced. Thus, the deformation of the window 400 for the mobile device may be prevented.

The support film 440 may be disposed on one side, e.g., the first side 410A, of the first resin layer 410. The support film 440 may be disposed between the first resin layer 410 and the display panel 100.

The support film 440 may be a general transparent plastic sheet or a polarizing film. The support film 440 may be a touch sensor panel.

Other embodiments of the invention are described with reference to FIGS. 3, 4 and 5.

FIG. 3 is a cross sectional view for describing the window for mobile device in accordance with other embodiments of the invention.

Referring to FIG. 3, the window for mobile device may include the first resin layer 410, the second resin layer 430 disposed on one side of the first resin layer 410, the support film 440 disposed on the other side of the first resin layer 410, and a third resin layer 450 disposed between the first resin layer 410 and the second resin layer 430.

The thickness of the third resin layer 450 may be 50 μm or less. The third resin layer 450 may include a transparent polymer resin. Desirably, the third resin layer 450 may include the same material as the first resin material 410. The third resin layer 450 may planarize an uneven plane that may generated by the support member 412 of the first resin layer 410. That is, the third resin layer 450 may be a type of planarization layer.

Thus, the third resin layer 450 may increase coherence of the first resin layer 410 and the second resin layer 430.

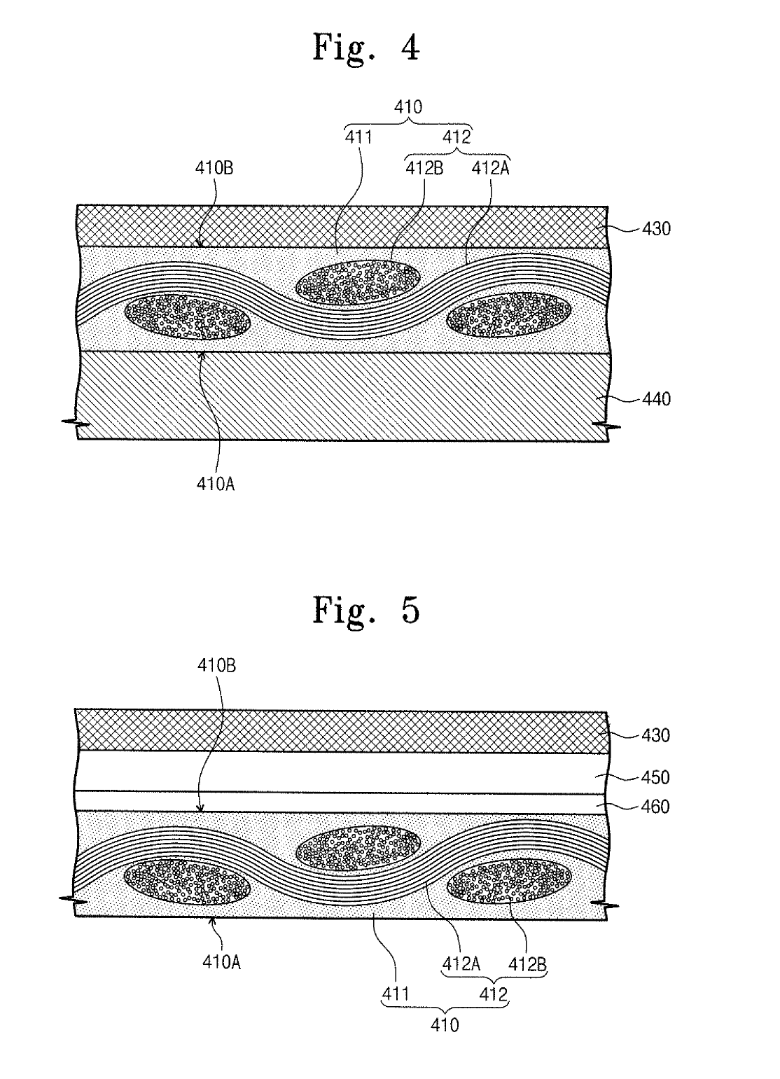

FIG. 4 is a cross sectional view for describing the window for mobile device in accordance with other embodiments of the invention.

Referring to FIG. 4, the window for mobile device includes the first resin layer 410, the second resin layer 430 disposed on one side of the first resin layer 410, and the support film 440 disposed on the other side of the first resin layer 410. The support member 412 of the first resin layer 410 may be one of a transparent textile, a glass cloth, a glass mat and a glass paper.

The first resin layer 410 may include the transparent adhesive resin 411 and the support member 412 impregnated in the transparent adhesive resin 411.

The coefficient of volume elasticity of the transparent adhesive resin 411 may be 0.1 GPa or less. It is desirable that the coefficient of volume elasticity of the transparent adhesive resin 411 be 0.01 GPa or less. The transparent adhesive resin 411 may include any one of a silicon adhesive resin, a rubber adhesive resin, an acrylic adhesive resin, a urethane adhesive resin and equivalent thereof. The acrylic adhesive resin may be an acrylic ester copolymer.

The support member 412 includes a plurality of first fiber aggregates 412A disposed in a specific direction and a plurality of second fiber aggregates 412B crossing the first fiber aggregates 412A.

The first and second fiber aggregates 412A and 412B, respectively, may include a plurality of fibers. Each fiber may include any one of E-glass material, T-glass material and NE-glass material.

Properties of the E-glass material, the T-glass material and the NE-glass material are as follows.

TABLE 2

| | E-glass | T-glass | NE-glass |
|---|---|---|---|
| | material | material | material |
| Density (g/cm²) | 2.58 | 2.46 | 2.30 |
| Coefficient of Volume | 72.5 | 84.3 | 65.7 |
| elasticity (GPa) | | | |
| Thermal expansion | 5.5 | 2.9 | 3.3 |
| coefficient (ppm/° C.) | | | |
| Refractive index | 1.558 | 1.521 | 1.503 |

Referring to the Table 2, since refractive indexes of the E-glass material, the T-glass material and the NE-glass material are 1.5˜1.6, the refractive index difference between the transparent adhesive resin 411 of the first resin layer 410 and the E, T and NE-glass materials may be 0.1 or less.

Thus, reduction of observability caused by a reflection ratio between the transparent adhesive resin 411 and the support member 412 may be prevented.

FIG. 5 is a cross sectional view for describing the window for mobile device in accordance with other embodiments of the invention.

Referring to FIG. 5, the window for mobile device may include the first resin layer 410, the second resin layer 430 disposed on one side of the first resin layer 410, the third resin layer 450 disposed between the first resin layer 410 and the second resin layer 430, and an adhesive layer 460 disposed between the first resin layer 410 and the third resin layer 450. The support member 412 of the first resin layer 410 may be any one of a transparent textile, a glass cloth, a glass mat and a glass paper.

The third resin layer 450 and the adhesive layer 460 include a transparent polymer resin. The third resin layer 450 may include the same material as the first resin layer 410. The adhesive layer 460 can planarize an uneven plane that may be generated by the support member 412 of the first resin layer 410. That is, the adhesive layer 460 may be a type of planarization layer.

The window for mobile device described above may be bent. Thus, a mobile device including the window for mobile device may also be bent.

While the present invention has particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A window for mobile device, comprising:
a first resin layer including a transparent adhesive resin and a plurality of support members distributed on the transparent adhesive resin; and
a second resin layer disposed on one side of the first resin layer and including a hard transparent resin.

2. The window for mobile device of claim 1, wherein a coefficient of volume elasticity of the transparent adhesive resin is not greater than 0.01 GPa.

3. The window for mobile device of claim 2, wherein the coefficient of volume elasticity of the transparent adhesive resin is not greater than 1 MPa.

4. The window for mobile device of claim 2, wherein the transparent adhesive resin is any one of a silicon adhesive resin, a rubber adhesive resin, an acrylic adhesive resin, and a urethane adhesive resin.

5. The window for mobile device of claim 1, wherein a coefficient of volume elasticity of the support members is not less than 1 GPa.

6. The window for mobile device of claim 5, wherein the support members are any one of a short staple and a spherical particle.

7. The window for mobile device of claim 6, wherein the support members comprise at least one of a silicate glass, an alumina ceramic and an acrylic organic.

8. The window for mobile device of claim 7, wherein the acrylic organic is polymethylmethacrylate (PMMA).

9. The window for mobile device of claim 5, wherein the support members comprise:
a plurality of first fiber aggregates disposed in a specific direction and spaced apart from one another; and
a plurality of second fiber aggregates crossing the first fiber aggregates.

10. The window for mobile device of claim 9, wherein the first and second fiber aggregates comprise a plurality of fibers, each fiber comprising any one of E-glass material, T-glass material and NE-glass material.

11. The window for mobile device of claim 1, wherein a difference between a refractive index of the support members and a refractive index of the transparent adhesive resin is not greater than 0.1.

12. The window for mobile device of claim 1, wherein a thickness of the first resin layer is in a range of 10 μm˜500 μm.

13. The window for mobile device of claim 12, wherein a thickness of the second resin layer is in a range of 5 μm˜100 μm.

14. The window for mobile device of claim 1, wherein a diameter of the support member is in a range of 2 μm˜100 μm.

15. The window for mobile device of claim 14, wherein a difference between a thickness of the first resin layer and the diameter of the support member is in a range of 0˜30 μm.

16. The window for mobile device of claim 15, wherein a difference between the thickness of the first resin layer and the diameter of the support member is in a range of 0˜10 μm.

17. The window for mobile device of claim 1, wherein the second resin layer comprises at least one of a Sil-Sesqui-Oxane resin, an acrylic resin, a polycarbonate resin, an allyl resin, a polyester resin and an epoxy resin.

18. The window for mobile device of claim 1, further comprising a support film disposed on another side of the first resin layer.

19. The window for mobile device of claim 18, wherein the support film is one of a transparent plastic sheet, a polarizing film and a touch sensor panel.

20. The window for mobile device of claim 18, wherein the support film comprises a transparent resin having a coefficient of volume elasticity not greater than 1 GPa.

21. The window for mobile device of claim 1, further comprising a third resin layer disposed between the first resin layer and the second resin layer and including a same material as the transparent adhesive resin.

22. The window for mobile device of claim 21, wherein a thickness of the third resin layer is not greater than 50 μm.

23. A mobile device, comprising:
a display panel displaying an image; and
a window for mobile device disposed in a direction in which light is outputted from the display panel;
wherein the window for mobile device comprises:
a first resin layer comprising a transparent adhesive resin and a plurality of support members distributed on the transparent adhesive resin and comprising a first side disposed toward the display panel and a second side facing the first side; and
a second resin layer disposed on the second side of the first resin layer and comprising a hard transparent resin.

24. The mobile device of claim 23, wherein a coefficient of volume elasticity of the transparent adhesive resin is not greater than 0.01GPa.

25. The mobile device of claim 23, wherein a coefficient of volume elasticity of the support members is not less than 1 GPa.

26. The mobile device of claim 25, wherein the support members are one of a short staple and a spherical particle distributed in the transparent adhesive resin.

27. The mobile device of claim 25, wherein the support members comprise:
a plurality of first fiber aggregates disposed in a specific direction and spaced apart from one another; and
a plurality of second fiber aggregates crossing the first fiber aggregates.

28. The mobile device of claim 23, wherein a difference between a refractive index of the support members and a refractive index of the transparent adhesive resin is not greater than 0.1.

29. The mobile device of claim 23, wherein the second resin layer comprises at least one of a Sil-Sesqui-Oxane resin, an acrylic resin, a polycarbonate resin, an allyl resin, a polyester resin and an epoxy resin.

30. The mobile device of claim 23, further comprising a support film disposed on the second side of the first resin layer.

31. The mobile device of claim 23, further comprising a third resin layer disposed between the first resin layer and the second resin layer and including a same material as the transparent adhesive resin.
